(19) United States
(12) Patent Application Publication
(10) Pub. No.: US 2020/0245402 A1
(43) Pub. Date: Jul. 30, 2020

(54) RLC SDU TRANSMISSION METHOD USED BY IAB NODE AND IAB NODE USING THE SAME

(71) Applicant: Industrial Technology Research Institute, Hsinchu (TW)

(72) Inventors: Chun-Yuan Chiu, Pingtung County (TW); Ching-Wen Cheng, Tainan City (TW)

(73) Assignee: Industrial Technology Research Institute, Hsinchu (TW)

(21) Appl. No.: 16/726,135

(22) Filed: Dec. 23, 2019

Related U.S. Application Data
(60) Provisional application No. 62/797,362, filed on Jan. 28, 2019.

(51) Int. Cl. H04W 80/02; H04W 28/06; H04L 12/801; H04W 36/02; H04L 1/00; H04L 5/00

(52) U.S. Cl. CPC H04W 80/02; H04W 28/06; H04L 5/0044; H04W 36/02; H04L 1/0007; H04L 47/34

(57) ABSTRACT

The disclosure is directed to an RLC SDU transmission method, and an IAB node using the same method. In as aspect, the RLC SDU transmission method is used by a first IAB node and includes: receiving a control signal from an IAB donor node; identifying a stray RLC SDU destined for the UE, associated with a sequence number, and not acknowledged by the second IAB node in response to receiving the control signal; and transmitting an RLC PDU to the second IAB node to inform the second IAB node of the stray RLC SDU.

### CROSS-REFERENCE TO RELATED APPLICATION

This application claims the priority benefit of U.S. provisional application Ser. No. 62/797,362, filed on Jan. 28, 2019. The entirety of the above-mentioned patent application is hereby incorporated by reference herein and made a part of this specification.

### TECHNICAL FIELD

The disclosure is directed to a radio link control (RLC) service data unit (SDU) transmission method used by a first integrated access and backhaul (IAB) node, an RLC SDU transmission method used by a second IAB node, and an IAB node using the same method.

### BACKGROUND

An IAB node functions as a base station in the radio access network (RAN) for the Fifth Generation (5G) New Radio (NR) communication network by providing wireless access for user equipment (UEs) to the network. An IAB node would typically have wireless backhaul capabilities through which the IAB would be able to connect to the network through one or more hops. FIG. 1 shows an example of IAB nodes A, B, and C in a RAN 100 which provides wireless connections to UEs 101. IAB node A communicate with IAB nodes B and C through wireless backhaul links and communicate with the network through a fiber transport. Benefits of the IAB of the 5G NR may include flexibility and dense employment of NR cells through wireless backhaul and relay links instead of densifying the transport network proportionally.

Deployments of IAB nodes would enhance system flexibility since IAB nodes may implement a topology adaptation mechanism dynamically by following a procedure which automatically re-configure the backhaul network under adverse circumstances such as blockages or local congestions without having to discontinue services for UEs. The multi-hop backhauling capability of IAB nodes would provide the IAB nodes longer range than a single hop. Since the IAB nodes would transmit at a very high frequency such as 6 GHz and above, having the multi-hop backhauling capability would be beneficial due to their limited range as the result of signal attenuation at the high frequency.

The IAB nodes may modify from existing Layer 2 (L2) and Layer 3 (L3) relay architecture to minimize required changes from the currently deployed systems. FIG. 2 shows an example of a UE accessing a network through IAB nodes including IAB-node 2, IAB-node 1, and IAB-donor. As seen in FIG. 2, the adaptation layer above the RLC has been introduced as a new protocol layer. The functions supported by the adaptation layer may include identifying a UE-bearer for a protocol data unit (PDU), routing a connection across a wireless backhaul topology, enforcing quality of service (QoS) by the scheduler for downlink (DL) and uplink (UL) on a wireless backhaul link, mapping of user plane PDUs of a UE to backhaul RLC channels, and so forth. Contents carried by a header of the adaption layer may include UE-bear specific identifier (ID), UE specific ID, route ID of IAB-node or IAB-donor address, QoS information, and so forth.

The IAB nodes may perform an automatic repeat request (ARQ) in a hop-by-hop manner. For RLC acknowledgement mode (AM), an ARQ is conducted hop-by-hop along access and backhaul links and have characteristics including having low re-transmission latency, requiring re-transmission only on one link for a package loss, and a hop count being unaffected by a maximum RLC window size. FIG. 3 shows a many-to-one mapping scheme between at least data radio bears (DRBs) and backhaul RLC channels.

Referring to FIG. 3, suppose that UE1 has DRB1 and DRB2, UE2 has DRB1 and DRB2, and UE3 has DRB1, DRB2, and DRB3, then different combinations of the DRBs of UE1, UE2, and UE3 could be multiplexed into one or more backhaul RLC channels as the grouping could be based on specific parameters such as bearer QoS profile. In the example of FIG. 3, a first backhaul RLC channel contains DRB1 of UE1, DRB1 of UE2, and DRB1 of UE3, a second backhaul RLC channel contains DRB2 of UE1 and URB3 of UE3, and a third backhaul RLC channel contains DRB2 of UE2 and DRB2 of UE3. The first, second, and third backhaul RLC channels would relay information from UE1, UE2, and UE2 to the network through IAB-node 2, IAB-node 1, and IAB-donor.

However, if there are transmission breakages that cannot be addressed by quick fixes such as handovers of UEs, high network traffic, an IAB node being offline, adverse channel conditions, and etc., then the network may apply a change to the backhaul topology. Thus, it would be conceivable that there would be stray RLC SDUs which are RLC SDUs that are transmitted but will not be received during a change of the backhaul topology or UE handovers. However, the current solution to minimize unnecessary transmission of stray RLC SDU has been non-existent or inadequate.

### SUMMARY OF THE DISCLOSURE

Accordingly, the disclosure is directed to an RLC SDU transmission method used by a first IAB node, an RLC SDU transmission method used by a second IAB node, and an IAB node using the same method.

In one of the exemplary embodiments, the disclosure is directed to an RLC SDU transmission method used by a first IAB node. The method would include not limited to: receiving a control signal from an IAB donor node; identifying a stray RLC SDU destined for the UE, associated with a sequence number, and not acknowledged by the second IAB node in response to receiving the control signal; and transmitting an RLC PDU to the second IAB node to inform the second IAB node of the stray RLC SDU.

In one of the exemplary embodiments, the disclosure is directed to an IAB node which includes not limited to a transmitter, a receiver, and a processor coupled to the transmitter and the receiver. The processor is configured at least to: receive, via the receiver, a control signal from an IAB donor node; identify a stray RLC SDU destined for the UE, associated with a sequence number, and not acknowledged by the second IAB node in response to receiving the control signal; and transmit, via the transmitter, a first RLC PDU to the second IAB node to inform the second IAB node of the stray RLC SDU.

In one of the exemplary embodiments, the disclosure is directed to an RLC SDU transmission method used by a second IAB node. The method would include not limited to: receiving, from a first IAB node, an RLC protocol data unit (PDU) which indicates an RLC SDU as a stray RLC SDU; treating the RLC SDU corresponding to the RLC PDU as a successfully received RLC SDU; and discarding an RLC SDU segment corresponding to the stray RLC SDU.

In order to make the aforementioned features and advantages of the present disclosure comprehensible, exemplary embodiments accompanied with figures are described in detail below. It is to be understood that both the foregoing general description and the following detailed description are exemplary, and are intended to provide further explanation of the disclosure as claimed.

It should be understood, however, that this summary may not contain all of the aspect and embodiments of the present disclosure and is therefore not meant to be limiting or restrictive in any manner. Also, the present disclosure would include improvements and modifications which are obvious to one skilled in the art.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 illustrates a current RAN backhaul architecture which includes IAB nodes provides wireless accesses to UEs.

FIG. 2 illustrates a current protocol stack for providing a network access to a UE through IAB nodes.

FIG. 3 illustrates mappings between UE DRBs and backhaul RLC channels for a current RAN backhaul architecture.

FIG. 4 illustrates occurrences of unnecessary transmission of stray RLC SDUs during a UE handover or a change of network topology.

FIG. 5 illustrates occurrences of stray RLC SDUs during a UE handover or a change of the current backhaul topology.

FIG. 6 illustrates discarding and re-routing stray RLC SDUs.

FIG. 7 is a flow chart which illustrates an RLC SDU transmission method used by a first IAB node according to an exemplary embodiment of the disclosure.

FIG. 8 is a flow chart which illustrates an RLC SDU transmission method used by a second IAB node according to an exemplary embodiment of the disclosure.

FIG. 9 illustrates a hardware block diagram of a first IAB node according to an exemplary embodiment of the disclosure.

FIG. 10 illustrates a hardware block diagram of a second IAB node according to an exemplary embodiment of the disclosure.

FIG. 11 illustrates the RLC SDU transmission method used by a first IAB node according to a first exemplary embodiment of the disclosure.

FIG. 12 illustrates the RLC SDU transmission method used by a second IAB node according to the first exemplary embodiment of the disclosure.

FIG. 13 illustrates using a new RLC control PDU to indicate stray RLC SDUs according to the first exemplary embodiment of the disclosure.

FIG. 14 illustrates using an alternative new RLC control PDU to indicate stray RLC SDUs according to the first exemplary embodiment of the disclosure.

FIG. 15 illustrates the RLC SDU transmission method used by a first IAB node according to a second exemplary embodiment of the disclosure.

FIG. 16 illustrates using a new RLC data PDU to indicate stray RLC SDUs according to the second exemplary embodiment of the disclosure.

FIG. 17 illustrates the content of a segmentation information (SI) field according to an embodiment of the disclosure.

FIG. 18 illustrates the RLC SDU transmission method used by a second IAB node according to the second embodiment of the disclosure.

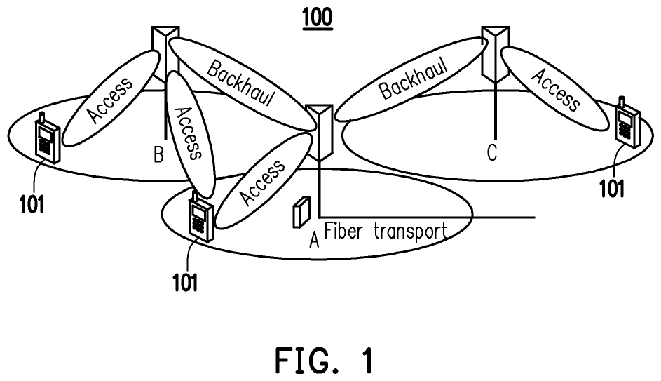

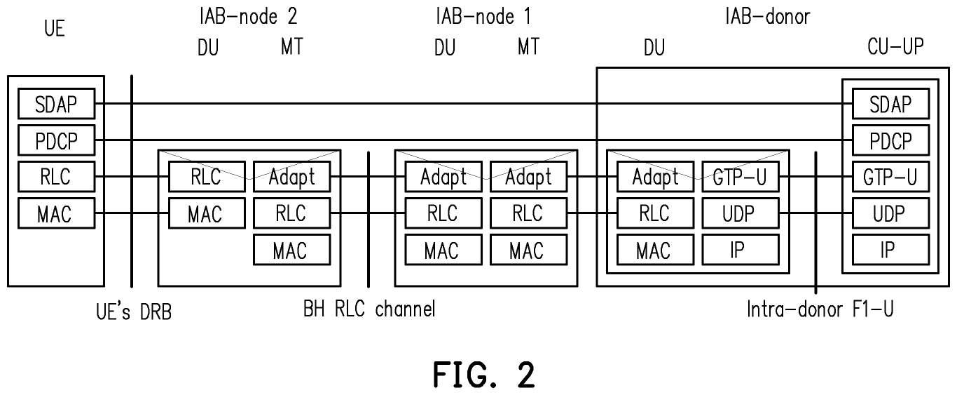

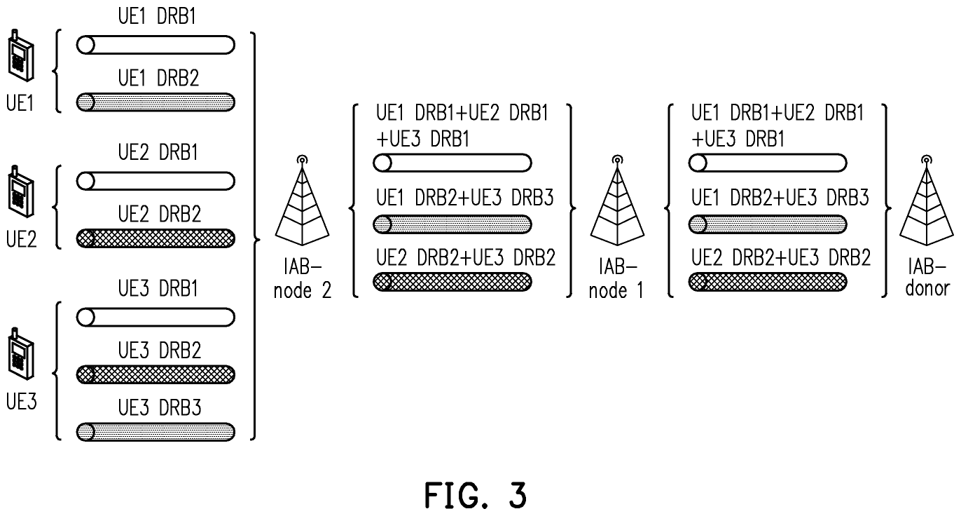

### DETAILED DESCRIPTION OF DISCLOSED EMBODIMENTS

Reference will now be made in detail to the present exemplary embodiments of the disclosure, examples of which are illustrated in the accompanying drawings. Wherever possible, the same reference numbers are used in the drawings and the description to refer to the same or like parts.

In order to cope with unnecessary transmission of RLC SDUs during a UE handover procedure or a change of the backhaul topology, the disclosure provides an RLC SDU transmission method used by a first IAB node and a second IAB node and also the first IAB node and the second IAB node which use the RLC SDU transmission method. The transmission of some RLC SDU being unnecessary means these RLC SDU are associated with a sequence number (SN) but not acknowledged (ACKed) by a receiving entity, and thus the receiving entity is not in the new routing path for these RLC SDUs after a UE handover procedure or a change of the backhaul topology. These RLC SDUs are stray RLC SDUs.

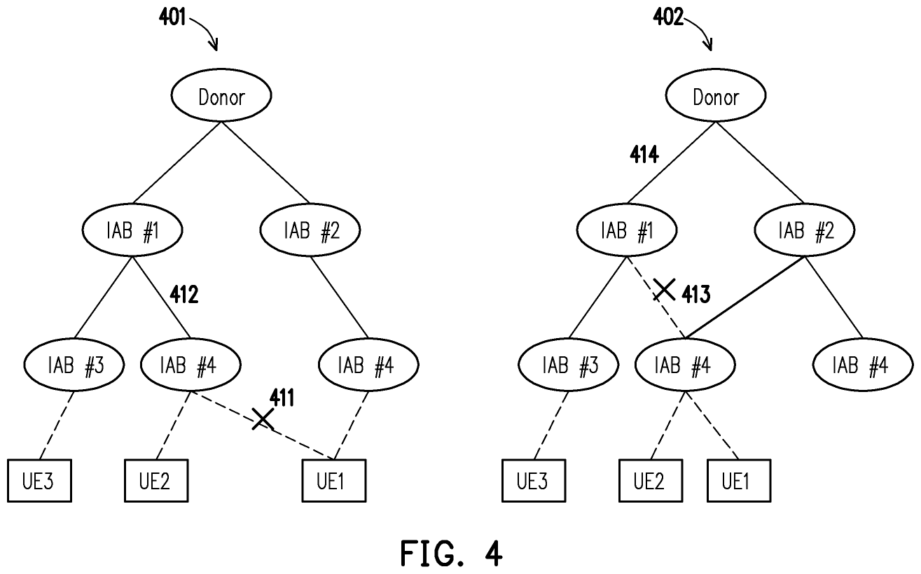

Occurrences of unnecessary transmission of stray RLC SDUs during a UE handover or a change of network topology is shown in FIG. 4. During a first scenario 401 in which a UE handover procedure occurs, the connection 411 between UE1 and IAB #4 would be severed at some point, and thus DL packets destined toward UE1 in an RLC channel 412 between IAB #1 and IAB #4 after the connection 411 has been severed would no longer be necessary. Similarly, during a second scenario 402 in which a change of the current backhaul topology occurs, the connection 413 between IAB #1 and IAB #4 could be severed, and thus DL packets that are transmitted from IAB donor to IAB #1 in an RLC channel 414 destined toward IAB #4 after the connection 413 has been severed would no longer be necessary.

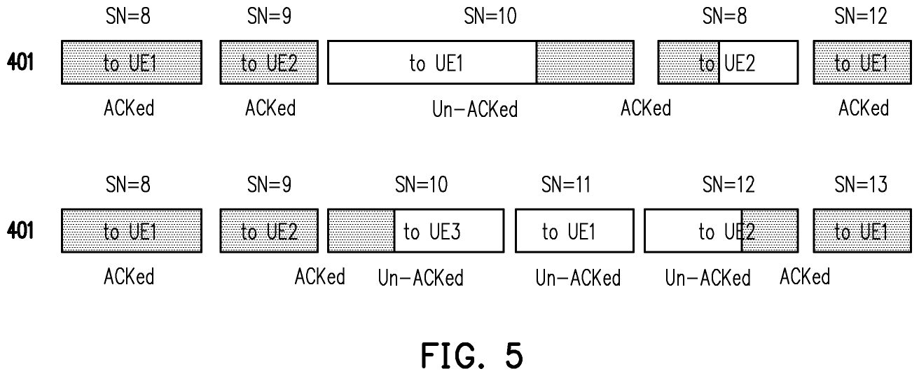

The occurrences of stray RLC SDUs during a UE handover or a change of the current backhaul topology is shown in FIG. 5. Referring to FIG. 5, it is assumed that there are DL packets in the RLC channel 412 between IAB #1 and IAB #4 for the first scenario 401 in which a UE handover procedure occurs, and the packet having the SN number 10 which is destined toward UE 1 could be unacknowledged (Un-ACKed). Thus, the packet with SN=10 would be considered as a stray packet (i.e. stray RLC SDUs). Similarly, it is assumed that there are DL packets in the RLC channel 414 between the IAB donor and IAB #1 for the second scenario 402 in which a change of backhaul topology occurs, and the packet having SN=10, SN=11 and SN=12 which are destined toward UE 3, UE 1 and UE 2 respectively would be unacknowledged (Un-ACKed). Thus, the packet with SN=11 and SN=12 would be considered as stray packets (i.e. stray RLC SDUs) since IAB #1 is no longer on the routing path of UE1 and UE2.

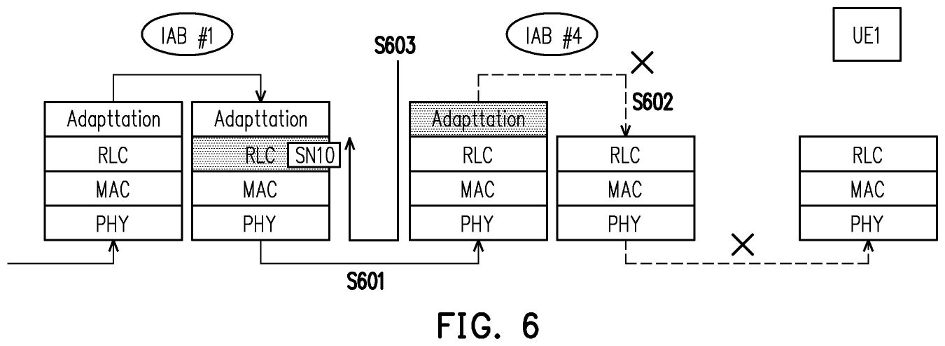

Referring to FIG. 6 for the first scenario 401, if IAB #1 gives up transmitting the packet with SN=10 to IAB #4 (S601), RLC window stalling may occur at IAB #4. If the packet with SN=10 is transmitted (S601), radio resources could be wasted since the received stray RLC SDU may end up being discarded (S602). In some circumstances, the waste of radio resources could be problematic since the number of the received stray RLC SDUs which end up being discarded could be large. If stray RLC SDUs are re-routed as shown (S603), occurrences of unnecessary transmission of the stray RLC SDUs could be twice (S601 and S603). To minimize the occurrences of stray RLC SDUs, the disclosure provides exemplary embodiments of two compatible solutions.

The embodiments of first solution would involve a new RLC control PDU to be sent from an RLC Tx entity of a first IAB node to an RLC Rx entity of a second IAB node to indicate which RLC SDU will not be transmitted further. The RLC Tx entity would skip the transmission of the stray RLC SDUs and treat them as RLC SDUs which have been acknowledged (ACKed). (When an RLC SDU has been transmitted by the RLC Tx entity, the RLC SDU will be ACKed if successfully received and decoded by the RLC Rx entity; otherwise, no ACK will be received or a NACK might be received.) The new RLC control PDU would also indicate which RLC SDUs are stray RLC SDUs. When receiving the RLC control PDU, the RLC Rx entity would also treat the stray RLC SDUs as successfully received RLC SDUs.

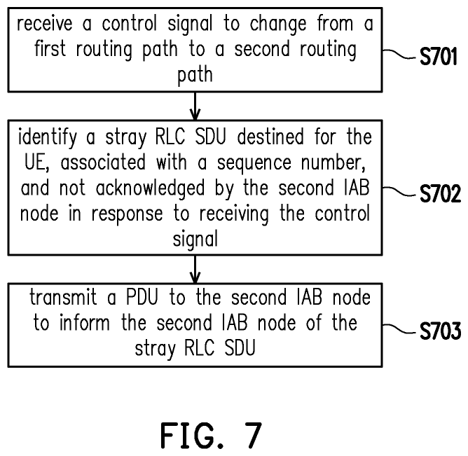

The embodiments of second solution would involve sending a dummy RLC PDU for each stray RLC SDU instead of sending the original RLC SDU. A dummy RLD PDU refers to an RLC PDU which only has an RLC header but does not have a SO field and does not carry any data. To further elucidate the above described solutions, FIG. 7˜FIG. 10 and their corresponding written description of exemplary embodiments serve to described the RLC transmission method used by a first IAB node and a second IAB node and related apparatuses using the method.

The RLC SDU transmission method used by a first IAB node is shown in FIG. 7. Referring to FIG. 7, in step S701, the first IAB node would receive a control signal from an IAB donor node used to change from a first routing path to a second routing path. In step S702, the first IAB node would identify a stray RLC SDU destined for the UE, associated with a sequence number, and not acknowledged by the second IAB node in response to receiving the control signal. In step S703, the first IAB node would transmit an RLC PDU to the second IAB node to inform the second IAB node of the stray RLC SDU. The first routing path has passed through the first IAB node, a second IAB node, and a UE but will be changed to a second routing path depending on whether a handover procedure of the UE has occurred or whether the backhaul topology has been changed.

According to an exemplary embodiment, the first IAB node would skip the transmission of the stray RLC SDU and treat the RLC SDU as an acknowledged RLC SDU. The RLC PDU for this exemplary embodiment is an RLC control PDU which indicates the stray RLC SDU. The RLC PDU may also be a dummy RLC PDU which would be sent instead of the stray RLC SDU.

According to an exemplary embodiment, there could be at least two ways to identify a stray RLC SDUs for each RLC Tx entity of the first IAB node. One way is to inspect a header in the stray RLC SDU to obtain a UE specific identifier (ID) for identifying a destination of the stray RLC SDU. Another way is to have the an adaptation layer of the first IAB node transfer an RLC SDU to the RLC Tx entity by indicating a UE specific ID of the RLC SDU to the RLC Tx entity, and the Tx entity records a correspondence (or mapping relationship) between the UE specific ID and a sequence number (SN) when the RLC SDU is associated with the SN.

According to an exemplary embodiment, the RLC control PDU may have one of at least two formats that could both be used by the first IAB node. The first format of the RLC control PDU may include a SN of a first stray RLC SDU and a bitmap to indicate the other stray RLC SDUs whose SNs are larger than the SN of the first stray RLC SDU. The second format of the RLC control PDU may include sequence numbers of stray RLC SDUs and a number of the sequence numbers of stray RLC SDUs.

According to an exemplary embodiment, the dummy RLC PDU may have the same SN as the stray RLC SDU. The dummy RLC PDU may not include any data field and SO field and includes a SI field which has two bits set to 00.

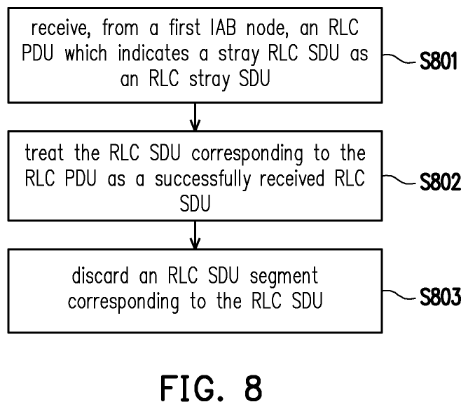

The RLC SDU transmission method used by a second IAB node is shown in FIG. 8. Referring to FIG. 8, in step S801, the second IAB node would receive, from a first IAB node, an RLC PDU which indicates an RLC SDU as a stray RLC SDU. In step S802, the second IAB node would treat the RLC SDU corresponding to the RLC PDU as a successfully received RLC SDU. In step S803, the second IAB node would discard the RLC SDU segment which corresponds to the RLC SDU.

In an exemplary embodiment of the disclosure, the RLC PDU is an RLC control PDU which indicates the stray RLC SDU. In an exemplary embodiment of the disclosure, the second IAB node would receive a dummy RLC PDU as the RLC PDU, and the dummy RLC PDU would indicate that the corresponding RLC SDU is a stray RLC SDU.

In an exemplary embodiment of the disclosure, the second IAB node would use one of at least two formats for the RLC control PDU. The first format of the RLC control PDU may include a SN of a first stray RLC SDU and a bitmap to indicate the other stray RLC SDUs whose SNs are larger than the SN of the first stray RLC SDU. The second format of the RLC control PDU may include sequence numbers of stray RLC SDUs and a number of the sequence numbers of stray RLC SDUs.

In an exemplary embodiment of the disclosure, the dummy RLC PDU may have the same SN as the stray RLC SDU. The dummy RLC PDU does not include any data field and SO field and includes a SI field which has two bits set to 00.

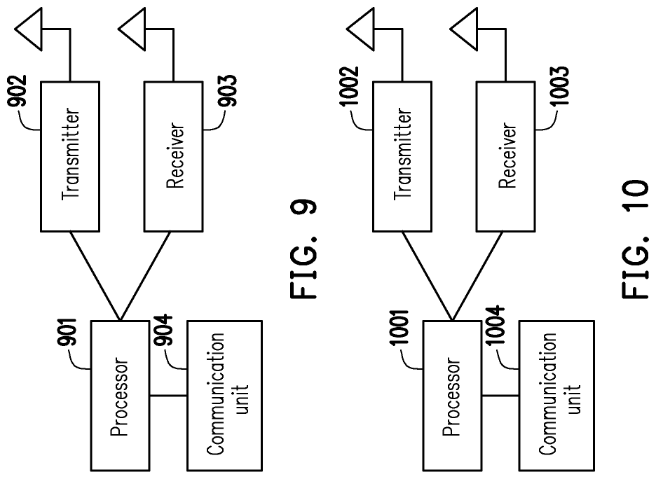

The hardware block diagram of the first IAB node is shown in FIG. 9. according to an exemplary embodiment of the disclosure. Referring to FIG. 9, the first IAB node may include a processor 901, a transmitter 902, a receiver 903, and optionally a storage medium 904. The processor 902 is coupled to the transmitter 902 and the receiver 903 and is configured at least to implement the RLC SDU transmission method used by a first IAB node as described in FIG. 7 and its exemplary embodiments.

The wireless transmitter 902 may include one or more transmitters, and the wireless receiver 903 may include one or more receivers configured to transmit and receive signals respectively in the radio frequency or in the mmWave frequency. The wireless transmitter 902 and receiver 903 may also perform operations such as low noise amplifying, impedance matching, frequency mixing, up or down frequency conversion, filtering, amplifying, and so forth. The wireless transmitter 902 and receiver 903 may each include one or more digital-to-analog (D/A) converters or analog-to-digital (A/D) converters which are configured to convert from an analog signal format to a digital signal format during uplink signal processing and from a digital signal format to an analog signal format during downlink signal processing. The wireless transmitter 902 and receiver 903 may each include an antenna array which may include one or multiple antennas to transmit and receive omni-directional antenna beams or directional antenna beams.

The non-transitory storage medium 904 would store programming codes, codebook configurations, buffered data, and record configurations assigned by the hardware processor 901. The hardware processor 901 could be implemented by using programmable units such as a micro-processor, a micro-controller, a DSP chips, FPGA, etc. The functions of the hardware processor 901 may also be implemented with separate electronic devices or ICs. It should be noted that the functions of hardware processor 901 may be implemented with either hardware or software.

The hardware block diagram of a second IAB node is shown in FIG. 10. Referring to FIG. 10, the second IAB node may include a processor 1001, a transmitter 1002, a receiver 1003, and optionally a storage medium 1004. The processor 1001 is coupled to the transmitter 1002 and the receiver 1003 and is configured at least to implement the RLC SDU transmission method used by the second IAB node as described in FIG. 8 and its exemplary embodiments. The functions of the elements 1001-1004 of FIG. 10 are similar to the functions of 901-904 of FIG. 9. However, the hardware of the second IAB node may or may not be identical to the hardware of the first IAB node.

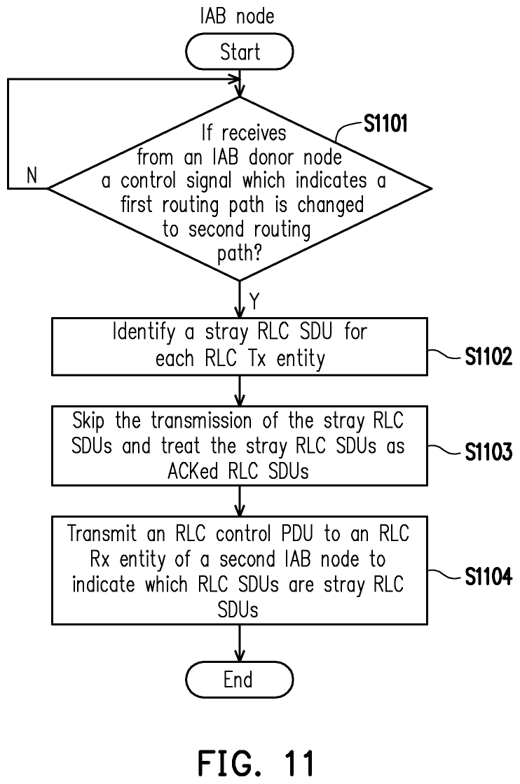

To further describing the above described concepts, the disclosure provides several exemplary embodiments. FIG. 11 illustrates the RLC SDU transmission method used by a first IAB node based on a first exemplary embodiment. The first IAB node could be an IAB node which receives from a donor IAB node, such as IAB #1 or IAB 2 as shown FIG. 4 and has at least one RLC Tx entity. Referring to FIG. 11, in step S1101, the first IAB node may determine if it receives from an IAB donor node a control signal which indicates whether a first routing path of a UE has changed to a second routing path. If yes, then in step S1102, the first IAB node may identify one or more stray RLC SDUs for each RLC Tx entity. In step S1103, the first IAB node may skip the transmission of the stray RLC SDUs and treat the stray RLC SDUs as ACKed RLC SDUs. In step S1104, the first IAB node would transmit an RLC control PDU to an RLC Rx entity of a second IAB node to indicate which RLC SDUs are stray RLC SDUs.

For step S1102, there could be two alternatives to identify stray RLC SDUs. For the first alternative, each RLC Tx entity may inspect the adaptation header in each RLC SDU to know the UE specific ID of each RLC SDU. Since the RLC Tx entity would know whether a routing path has been severed, the RLC Tx entity would know whether a routing path would reach a UE corresponding to the UE specific ID. For the second alternative, the adaptation layer would transfer RLC SDUs to the RLC Tx entity by indicating the UE-specific ID for each RLC SDU. When an RLC SDU is associated with a SN, the RLC Tx entity would record the mapping between the UE specific ID and the SN. In this way, the RLC Tx entity would know which RLC SDU is a stray RLC SDU based on the SN of the RLC SDU and its relationship with the UE specific ID.

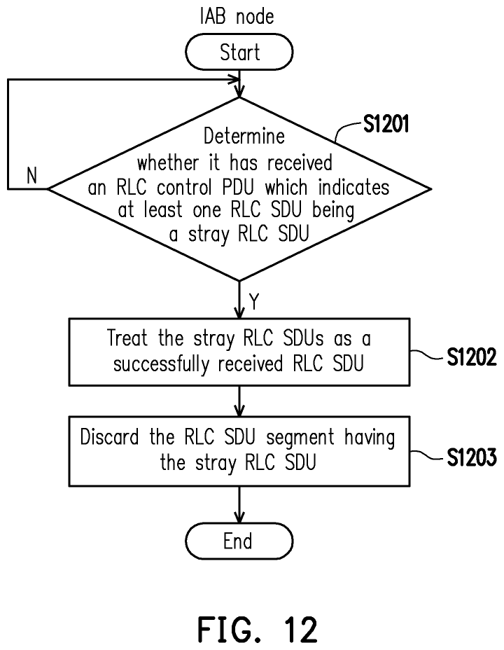

FIG. 12 illustrates the RLC SDU transmission method used by the second IAB node according to the first exemplary embodiment. The second IAB node could be an IAB node which receives from a first IAB node, such as IAB #3 or IAB 4 or IAB #5 as shown FIG. 4 and has at least one RLC Rx entity. In step S1201, the second IAB node would determine whether it has received an RLC control PDU which indicates at least one RLC SDU being a stray RLC SDU. If yes, then in step S1202, the second IAB node would treat the stray RLC SDUs as a successfully received RLC SDU. In step S1203, the second IAB node would discard the RLC SDU segment having the stray RLC SDU.

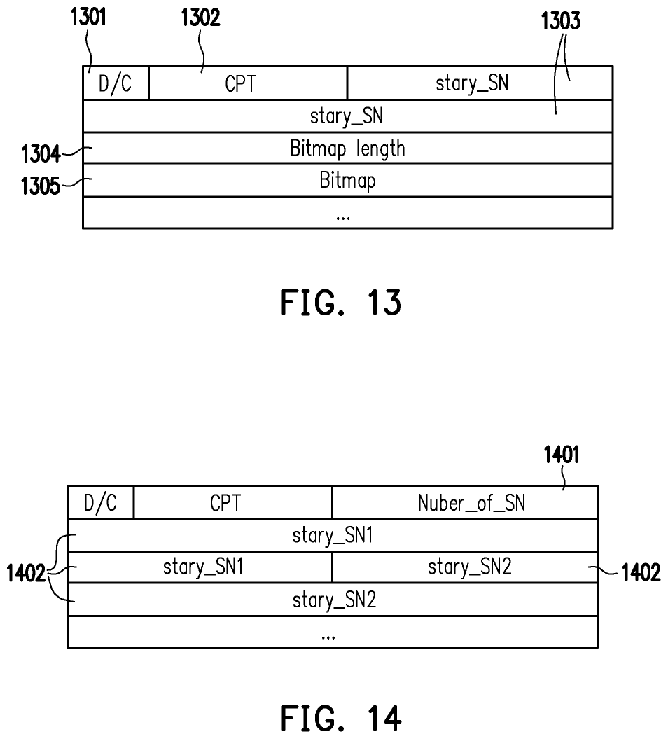

In order to use an RLC PDU to indicate a stray RLC SDU, the disclosure proposes a new RLC control PDU for the first exemplary embodiment as shown in FIG. 13. The new RLC control PDU may include not limited to a D/C field 1301, a CPT field 1302, a stray_SN field 1303, a Bitmap length field 1304, and a Bitmap field 1305. A D/C field 1301 could be used to indicate whether the RLC PDU is an RLC data PDU or an RLC control PDU. The CPT field 1302 could be used to indicate a type of the RLC control PDU. The stray_SN field 1303 could be used to indicate the SN of a first stray RLC SDU. The Bitmap length field 1304 could be used to indicate the length of the following bitmap. The Bitmap length field 1304 could be removed if the total length of RLC control PDU is indicated in the lower layer such as by indicating the total length in a length field of a media access control (MAC) subheader. The Bitmap field 1305 could be used to indicate the other stray RLC SDUs after the first stray RLC SDU.

FIG. 14 illustrates using an alternative new RLC control PDU to indicate stray RLC SDUs according to the first exemplary embodiment of the disclosure. The new RLC control PDU of FIG. 13 and the alternative new RLC control PDU of FIG. 14 are RLC control PDUs of different formats but could be simultaneously adopted and distinguished by using the CPT field or an additional bit to indicate which format is used. The alternative new RLC control PDU would include a D/C field, a CPT field, a Number_of_SN field 1401, and a stray_SNi field 1402 where i is an integer incrementing by 1 and starting from 1 for each of the following stray_SNi fields. The functions of the D/C field and the CPT field are identical to FIG. 13. The Number of SN field 1401 could be used to indicate the quantity of stray_SNi fields to be followed. The Number_of_SN field 1401 could be removed if the total length of RLC control PDU is indicated in the lower layer such as by indicating the total length in a length field of a MAC subheader. Each of the stray_SNi field(s) could be used to indicate the SN of the i^{th} stray RLC SDU.

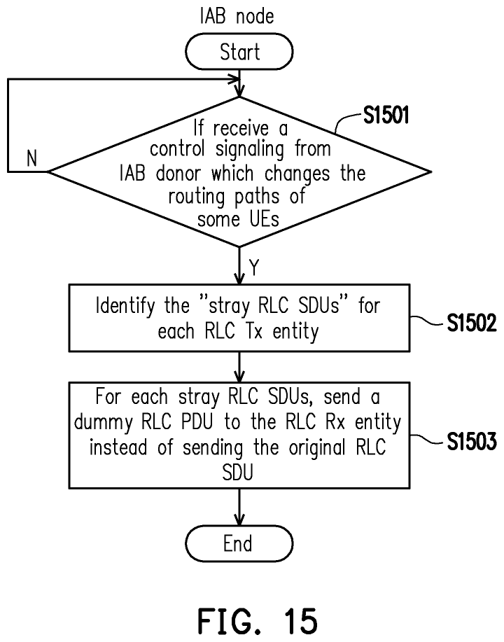

FIG. 15 illustrates the RLC SDU transmission method used by a first IAB node according to a second exemplary embodiment of the disclosure. The first IAB node could be an IAB node which receives from a donor IAB node, such as IAB #1 or IAB 2 as shown FIG. 4 and has at least one RLC Tx entity. In step S1501, the first IAB node would determine whether it receives from an IAB donor node a control signal which changes from a first routing path of a UE to a second routing path. If yes, then in step S1502, the first IAB node would identify one or more stray RLC SDU for each RLC Tx entity. In step S1503, the first IAB node would construct and transmit a dummy RLC PDU to an RLC Rx entity of a second IAB node for each stray RLC SDU instead of transmitting the original RLC SDU.

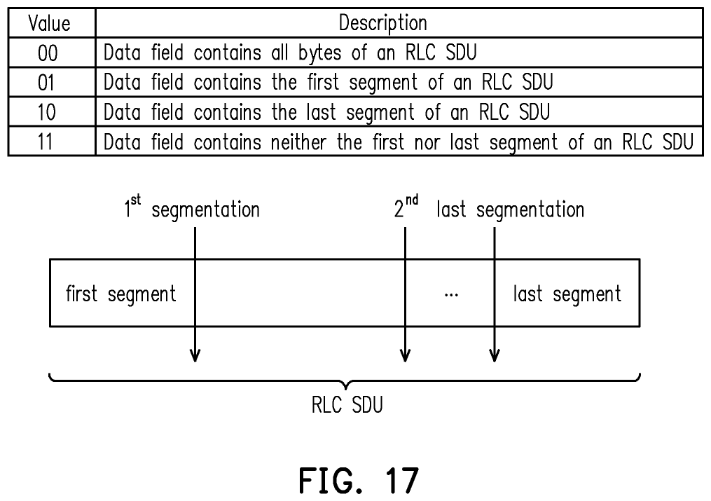

The first IAB node would construct the dummy RLC PDU for each stray RLC SDU as follows. For an RLC SDU with SN=x, the SN of the corresponding dummy RLC PDU would also have its SN=x. If the RLC PDU corresponding to the stray RLC SDU has already been constructed, the first IAB node would remove the data payload from the RLC SDU, change the SI field to “00”, remove the SO field if there is any, and leave the P field and the SN field unchanged. An example of the SI field is shown in FIG. 17 to be explained later. If the RLC PDU corresponding to the RLC SDU has not been constructed yet, then the first IAB node would construct a dummy RLC PDU with only the RLC header with SN=x.

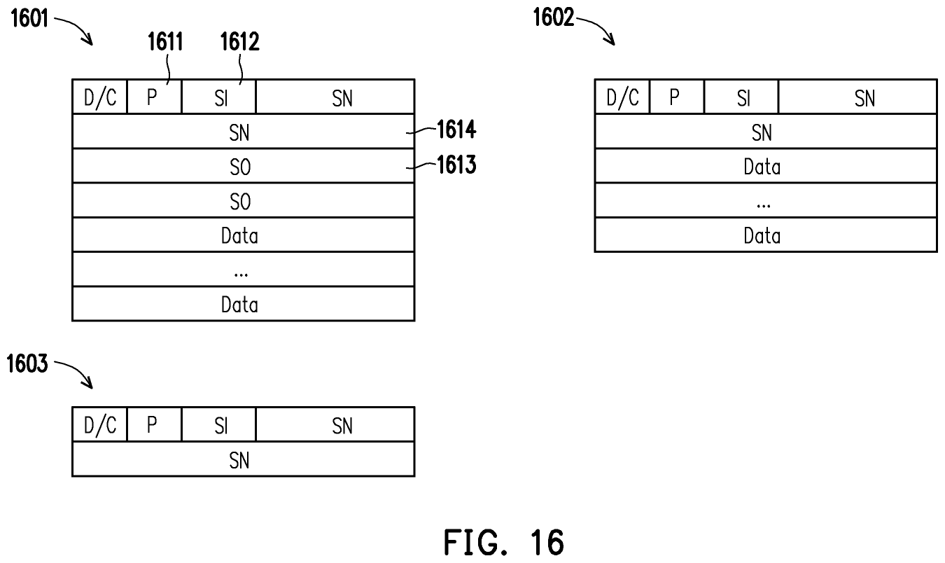

FIG. 16 shows the traditional RLC data PDUs 1601 1602 and a new RLC data PDU 1603 for indicating stray RLC SDUs based on the second exemplary embodiment. The traditional RLC data PDU 1601 includes a P field 1611, a SI field 1612, a SO field 1613, and a SN field 1614. The P field 1611 could be used to indicate whether or not the transmitting side of an acknowledged mode (AM) RLC entity requests a status report from its peer AM RLC entity. The SI field 1612 could be used to indicate whether an RLC PDU contains a complete RLC SDU or the first, middle, and last segment of an RLC SDU. The SO 1613 could be used to indicate the position of the RLC SDU segment in bytes within the original RLC SDU. The SN field 1614 could be used to indicate the sequence number of the corresponding RLC SDU. The traditional RLC data PDU 1602 which has a similar format but does not have any SO field are used if the SI field indicates the RLC PDU contains a complete RLC SDU. For the new RLC data PDU 1603 which is a dummy RLC PDU would be similar to the traditional RLC data PDUs 1601 1602 but does not carry any data and contain any SO field.

The above describe SI field is shown in FIG. 17. The SI field contains two bits which indicate whether an RLC PDU contain a complete RLC SDU or just a first segment of an RLC SDU, just a last segment of an RLC SDU, or neither the first segment nor the last segment of an RLC SDU. More specifically, the binary number 00 would indicate that the data field of the corresponding RLC PDU contains all bytes of an RLC SDU, the binary number 01 would indicate that the data field of the corresponding RLC PDU contains only the first segment of an RLC SDU, the binary number 10 would indicate that the data field of the corresponding RLC PDU contains only the last segment of an RLC SDU, and the binary number 11 would indicate that the data field of the corresponding RLC PDU contains neither the first segment nor the last segment of an RLC SDU.

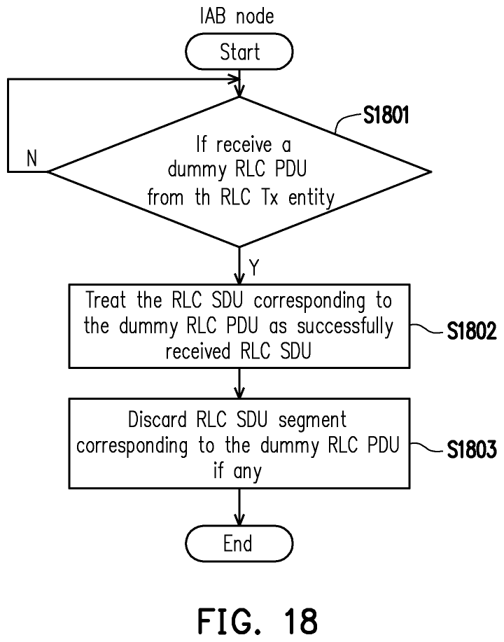

FIG. 18 illustrates the RLC SDU transmission method used by a second IAB node according to the second embodiment of the disclosure. The second IAB node could be an IAB node which receives from a first IAB node, such as IAB #3 or IAB 4 or IAB #5 as shown FIG. 4 and has at least one RLC Rx entity. In step S1801, the second IAB node would determine whether it has received from an RLC Tx entity of a first IAB node a dummy RLC PDU. If yes, then in step S1802, the second IAB node would treat the RLC SDU corresponding to the dummy RLC PDU as a successfully received RLC SDU. In step S1803, the second IAB node would discard the RLC SDU segment corresponding to the RLC PDU if there is any.

In view of the aforementioned descriptions, the present disclosure is suitable for being used in a 5G wireless communication system and is able to minimize unnecessary transmission of RLC SDUs as the result of a change of the wireless backhaul topology or a handover procedure of a UE.

No element, act, or instruction used in the detailed description of disclosed embodiments of the present application should be construed as absolutely critical or essential to the present disclosure unless explicitly described as such. Also, as used herein, each of the indefinite articles “a” and “an” could include more than one item. If only one item is intended, the terms “a single” or similar languages would be used. Furthermore, the terms “any of” followed by a listing of a plurality of items and/or a plurality of categories of items, as used herein, are intended to include “any of”, “any combination of”, “any multiple of”, and/or “any combination of multiples of the items and/or the categories of items, individually or in conjunction with other items and/or other categories of items. Further, as used herein, the term “set” is intended to include any number of items, including zero. Further, as used herein, the term “number” is intended to include any number, including zero.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A radio link control (RLC) service data unit (SDU) transmission method used by a first integrated access and backhaul (IAB) node, the method comprising:
receiving a control signal from an IAB donor node;
identifying a stray RLC SDU destined for a user equipment (UE), associated with a sequence number, and not acknowledged by a second IAB node in response to receiving the control signal; and
transmitting an RLC protocol data unit (PDU) to the second IAB node to inform the second IAB node of the stray RLC SDU.

2. The RLC SDU transmission method of claim 1 further comprising:
skipping a transmission of the stray RLC SDU; and
treating the RLC SDU as an acknowledged RLC SDU, wherein the RLC PDU is an RLC control PDU which indicates the stray RLC SDU.

3. The RLC SDU transmission method of claim 1, wherein the RLC PDU is a dummy RLC PDU which is sent instead of the stray RLC SDU.

4. The RLC SDU transmission method of claim 1, wherein identifying a stray RLC SDU destined for the UE, associated with a sequence number, and not acknowledged by the second IAB node in response to receiving the control signal comprising:
inspecting a header in the stray RLC SDU to obtain a UE specific identifier (ID) for identifying a destination of the stray RLC SDU.

5. The RLC SDU transmission method of claim 1, wherein the first IAB node comprises an adaptation layer and an RLC transmitter (Tx) entity as the adaptation layer transfers an RLC SDU to the RLC Tx entity by indicating a UE specific ID of the RLC SDU to the RLC Tx entity, and the Tx entity records a correspondence between the UE specific ID and a sequence number (SN) when the RLC SDU is associated with the SN.

6. The RLC SDU transmission method of claim 2, wherein a first format of the RLC control PDU comprises a SN of a first stray RLC SDU and a bitmap to indicate the other stray RLC SDUs whose SNs are larger than the SN of the first stray RLC SDU.

7. The RLC SDU transmission method of claim 2, wherein a second format of the RLC control PDU comprises sequence numbers of stray RLC SDUs and a number of the sequence numbers of stray RLC SDUs.

8. The SDU transmission method of claim 3, wherein the dummy RLC PDU has the same SN as the stray RLC SDU.

9. The SDU transmission method of claim 3, wherein the dummy RLC PDU does not include any data field and SO field and includes a SI field which has two bits set to 00.

10. The SDU transmission method of claim 1, wherein the control signal received from the IAB donor node is used to change from a first routing path, passing through the first IAB node, the second IAB node, and the UE, to a second routing path.

11. The SDU transmission method of claim 10, wherein the changing from the first routing path, passing through the first IAB node, the second IAB node, and the UE, to the second routing path occurs during a handover procedure of the UE or during a change of a backhaul topology which comprises the IAB donor node, the first IAB node, and the second IAB node.

12. The SDU transmission method of claim 2, wherein a first format of the RLC control PDU comprises a SN of a first stray RLC SDU and a bitmap to indicate the other stray RLC SDUs whose SNs are larger than the SN of the first stray RLC SDU, wherein a second format of the RLC control PDU comprises sequence numbers of stray RLC SDUs and a number of the sequence numbers of stray RLC SDUs, and wherein the first IAB node uses both the first format and the second format.

13. An IAB (integrated access and backhaul) node comprising:
a transmitter;
a receiver; and
a processor coupled to the transmitter and the receiver and configured to:
receive, via the receiver, a control signal from an IAB donor node;
identify a stray RLC SDU destined for a user equipment (UE), associated with a sequence number, and not acknowledged by a second IAB node in response to receiving the control signal; and
transmit, via the transmitter, a first RLC protocol data unit (PDU) to the second IAB node to inform the second IAB node of the stray RLC SDU.

14. A radio link control (RLC) service data unit (SDU) transmission method used by a second integrated access and backhaul (IAB) node, the method comprising:
receiving, from a first IAB node, an RLC protocol data unit (PDU) which indicates an RLC SDU as a stray RLC SDU;
treating the RLC SDU corresponding to the RLC PDU as a successfully received RLC SDU; and
discarding an RLC SDU segment corresponding to the RLC SDU.

15. The RLC SDU transmission method of claim 14, wherein the RLC PDU is an RLC control PDU which indicates the stray RLC SDU.

16. The RLC SDU transmission method of claim 14, wherein the RLC PDU is a dummy RLC PDU which is received as the stray RLC SDU.

17. The RLC SDU transmission method of claim 15, wherein a first format of the RLC control PDU comprises a SN of a first stray RLC SDU and a bitmap to indicate the other stray RLC SDUs whose SNs are larger than the SN of the first stray RLC SDU.

18. The RLC SDU transmission method of claim 15, wherein a second format of the RLC control PDU comprises sequence numbers of stray RLC SDUs and a number of the sequence numbers of stray RLC SDUs.

19. The RLC SDU transmission method of claim 16, wherein the dummy RLC PDU has the same SN as the stray RLC SDU.

20. The SDU transmission method of claim 16, wherein the dummy RLC PDU does not include any data field and SO field and includes a SI field which has two bits set to 00.
